(19) United States
(12) Patent Application Publication
(10) Pub. No.: US 2007/0050696 A1
(43) Pub. Date: Mar. 1, 2007

(54) Physical key for accessing a securely stored digital document

(76) Inventors: Kurt Wesley Piersol, Santa Cruz, CA (US); Gregory J. Wolff, Redwood City, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/639,282

(22) Filed: Aug. 11, 2003

Related U.S. Application Data
(63) Continuation-in-part of application No. 10/404,916, filed on Mar. 31, 2003.
(63) Continuation-in-part of application No. 10/404,927, filed on Mar. 31, 2003.

(51) Int. Cl. G06F 17/00

(52) U.S. Cl. 715/500

(57) ABSTRACT

An incoming document is scanned, encrypted, and stored. A decryption key is generated and output on a physical artifact, such as a printed sheet of paper. The decryption key is not stored in any other location. The physical artifact can later be presented to access, decrypt, and output the stored document. Additional features of some embodiments of the invention include user authentication, key expiry, and watermarking.

### CROSS-REFERENCE TO RELATED APPLICATIONS

This application is a continuation-in-part of U.S. patent application Ser. No. 10/404,916 titled “Method and Apparatus for Composing Multimedia Documents,” filed Mar. 31, 2003, the disclosure of which is incorporated by reference.

This application is a continuation-in-part of U.S. patent application Ser. No. 10/404,927 titled “Multimedia Document Sharing Method and Apparatus,” filed Mar. 31, 2003, the disclosure of which is incorporated by reference.

This application is related to the following commonly owned and co-pending U.S. patent applications, the disclosures of which are incorporated by reference:
U.S. patent application Ser. No. 09/521,252 titled “Method and System for Information Management to Facilitate the Ex-
U.S. patent application Ser. No. 10/001,895 titled “Paper-Based Interface For Multimedia Information,” filed Nov. 19, 2001;
U.S. patent application Ser. No. 10/081,129 titled “Multimedia Visualization & Integration Environment,” filed Feb. 21, 2002;
U.S. patent application Ser. No. 10/085,569 titled “A Document Distribution and Storage System,” filed Feb. 26, 2002;
U.S. patent application Ser. No. 10/174,522 titled “Television-based Visualization and Navigation Interface,” filed Jun. 17, 2002;
U.S. patent application Ser. No. 10/175,540 titled “Device For Generating A Multimedia Paper Document,” filed Jun. 18, 2002; and
U.S. patent application Ser. No. 10/307,235 titled “Multimodal Access of Meeting Recordings,” filed Nov. 29, 2002.

### BACKGROUND OF THE INVENTION

### Field of the Invention

This invention relates generally to document management, and more specifically to generation and handling of decryption keys for securely stored documents.

### BACKGROUND OF THE INVENTION

Despite the ideal of a paperless environment that the popularization of computers had promised, paper continues to dominate the office landscape. Ironically, the computer itself has been a major contributing source of paper proliferation. The computer simplifies the task of document composition, and thus has enabled even greater numbers of publishers. Oftentimes, many copies of a document must be made so that the document can be shared among colleagues, thus generating even more paper.

Despite advances in technology, practical substitutes for paper remain to be developed. Computer displays, PDAs (personal digital assistants), wireless devices, and the like all have their various advantages, but they lack the simplicity, reliability, portability, relative permanence, universality, and familiarity of paper. In many situations, paper remains the simplest and most effective way to store and distribute information.

One advantage of paper is the ease with which it can be kept secure. Because of the ubiquity of paper in office environments, people have grown accustomed to methods of controlling access to information stored and distributed on paper. For example, companies often maintain their sensitive paper files in locked cabinets or rooms. In addition, to help ensure certain data remains confidential after the usefulness to a company of a particular document is exhausted, companies often adopt and follow document retention policies. These polices specify conditions under which certain paper documents are destroyed. People trust that once a paper document is shredded, for example, no further copies of it can be made, and others will not be able to learn the contents of the document. Thus, the inherent security provided by being able to lock up and later destroy paper documents is a major reason why people choose to record some of their most secret information on paper.

The convenience and security advantages that paper offers signal that its complete replacement is not likely to occur soon, if ever. Perhaps then, the role of the computer is not to achieve a paperless society. Instead, the role of the computer may be as a tool to move effortlessly between paper and electronic representations and maintain connections between the paper and the electronic media with which it was created.

In U.S. Pat. No. 5,754,308, “System and Method for Archiving Digital Versions of Documents and for Generating Quality Printed Documents Therefrom,” Lopresti et al. describe one method for moving between paper and electronic representations. The system uses an enhanced copier to scan a document information designator present on each page that uniquely identifies that page and enables retrieval of a stored digital representation of that page for output. This system requires hard copies of each page to be used for retrieval and does not guarantee security during the storage or retrieval processes.

Related, commonly owned applications for “Method and Apparatus for Composing Multimedia Documents,” and “Multimedia Document Sharing Method and Apparatus,” the disclosures of which are incorporated herein by reference, describe techniques for organizing multimedia documents into one or more collections. A collection coversheet representative of the collection can be printed on a suitable medium, such as paper. This coversheet can provide access to the collection by using a multi-function peripheral (MFP). In this way, individuals can share multimedia documents in the collection by distributing copies of the coversheet to recipients.

Most prior methods to address document security concerns involve access control methods that require an administrator to be trusted by users. Typically, the administrator has the right to change access codes or access particular documents. In the case of a public MFP, for instance at a copy shop, such protection systems are probably inappropriate. Some customers desire a higher level of ensured privacy and would prefer to prevent, for example, a copy shop administrator from gaining access to their secure documents.

Another access control method to address these document security concerns is to use encryption. Most encryption methods rely on electronic decryption keys. Secure handling of these encryption keys often becomes the weak link in the overall security of the document management system. Because most existing systems use electronic means of key storage and management, users often feel as though they have less control over the handling, transferring and replication of electronic keys as they feel when dealing with physical objects. In addition, some existing encryption methods require the expensive addition of special hardware to support the storage and input of decryption keys. Requiring the user to manually enter a decryption key (which can often exceed 256 bits in length) is a poor solution, since such keys are difficult to memorize, and difficult to manually type accurately.

Existing systems do not provide an easy mechanism for storing, handling, transferring, and otherwise handling decryption keys. They also fail to provide an easy way to use such keys to access secure documents. What is needed is a secure document storage and access control method that provides a simple, reliable mechanism for storing, handling, and using decryption keys for encrypted documents.

### SUMMARY OF THE INVENTION

According to the present invention decryption keys are stored on a physical artifact, such as a printed sheet of paper, which is later used for accessing, decrypting, and outputting a stored document. No electronic copy of the key is permanently stored. Using a key embodied in a physical artifact to access encrypted electronic documents has several advantages, including in particular allowing users to retain physical control over the key. Many users find such control reassuring, and associate such control with increased security. Paper is an ideal form of physical artifact for such purposes, since paper keys can be easily generated using common equipment (a printer). Furthermore, paper is cheap, compact, and familiar to users.

The key embodied on the paper (or other physical artifact) is provided on a tangible physical object, so users can rely on their established routines for securely storing physical objects. For example, users can guard their physical access key in much the same way as they guard their car or house keys. In addition, the physical key is easily transferable, in the same manner as a conventional key to a locked filing cabinet. The fact that the physical access key has a tangible presence also reassures users that it is capable of being destroyed to prevent future access to the document. Moreover, the fact that the access key is physical takes advantage of user intuition about the limitations to replication of physical objects. With electronically stored data, users are often concerned about where else in memory the information may exist as a copy, a concern that is lessened when dealing with artifacts in the physical world.

The physical access key is generated in the present invention when a document is scanned or otherwise input to a device such as a multi-function peripheral (MFP). The document is then encrypted and stored in encrypted form. After generating the key for decrypting the document, the MFP outputs a representation of the key on a non-electronic media. In one embodiment, as described below, the representation of the key is printed on a sheet of paper. The user may then share or distribute the key at will, for example by giving the piece of paper (or copies of it) to authorized users. Known techniques of physical duplication (such as photocopying, for example), can be used to make backup copies of the access key.

When the key is later presented (for example by scanning the paper), the MFP retrieves the stored encrypted document, decrypts the document using the key, and outputs the decrypted document. In this way, only authorized users can access a decrypted copy of the document.

According to other aspects of the invention, multiple versions of a decryption key are generated and printed, each version containing unique watermarking information. When a user presents a particular version of a decryption key, the MFP retrieves the stored encrypted document, decrypts the document using the presented key, and outputs the decrypted document with the unique watermark associated with that key embedded in the document (e.g., using steganographic techniques). Thus, subsequent output or copies bearing a watermark can be traced back to the original user of the key with the associated watermark.

Further features of the invention, its nature and various advantages will be more apparent from the accompanying drawings and the following detailed description.

### BRIEF DESCRIPTION OF THE DRAWINGS

The accompanying drawings illustrate several embodiments of the invention and, together with the description, serve to explain the principles of the invention.

FIG. 1 is a block diagram depicting encryption of a document and generation of a physical access key, according to one embodiment of the present invention.

FIG. 2 is a block diagram depicting decryption of a stored document using a physical access key, according to one embodiment of the present invention.

FIG. 3 is a flow diagram depicting a method of encrypting and storing a document and generating a physical access key, according to one embodiment of the present invention.

FIG. 4 is a flow diagram depicting a method of accessing a stored document using a physical access key, according to one embodiment of the present invention.

FIG. 5 is an example of a physical access key.

FIG. 6 is a flow diagram depicting a method of encrypting and storing a document and generating a split physical access key, according to one embodiment of the present invention.

FIG. 7 is a flow diagram depicting a method of accessing a stored document using a split physical access key, according to one embodiment of the present invention.

### DETAILED DESCRIPTION OF THE EMBODIMENTS

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey the invention to those skilled in the art.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

In this application, the term “document” refers to any collection of information capable of being stored electronically, including but not limited to text, word processing and spreadsheet files, email messages, voice and audio recordings, images and video recordings. The term “document” may also refer to a representation of a collection of any number of electronic computer files, which might be obtained from one or more sources. For example, a series of scanned pages, combined with images produced by a digital camera and stored on a flash memory card, combined with an email cover sheet, might constitute a single document.

Inputting a Securely Stored Digital Document

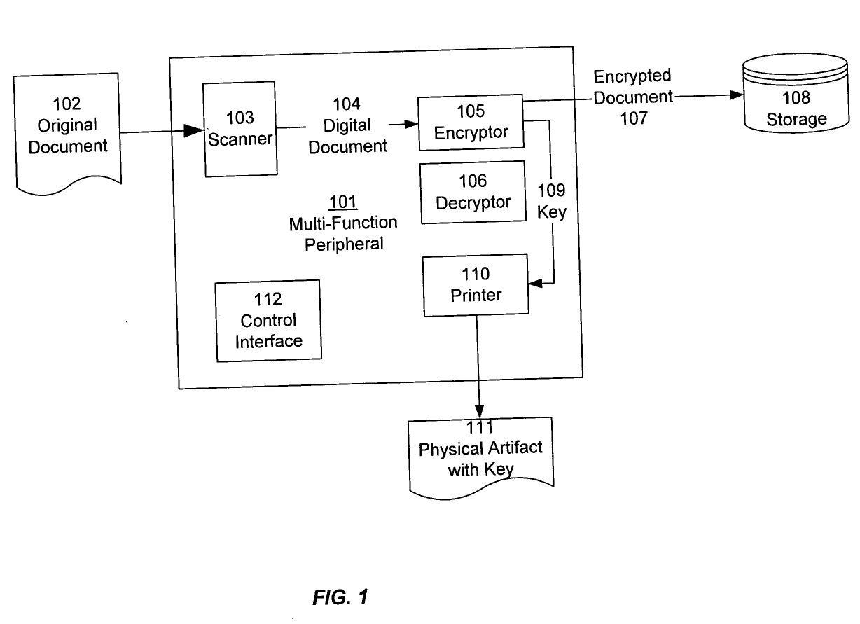

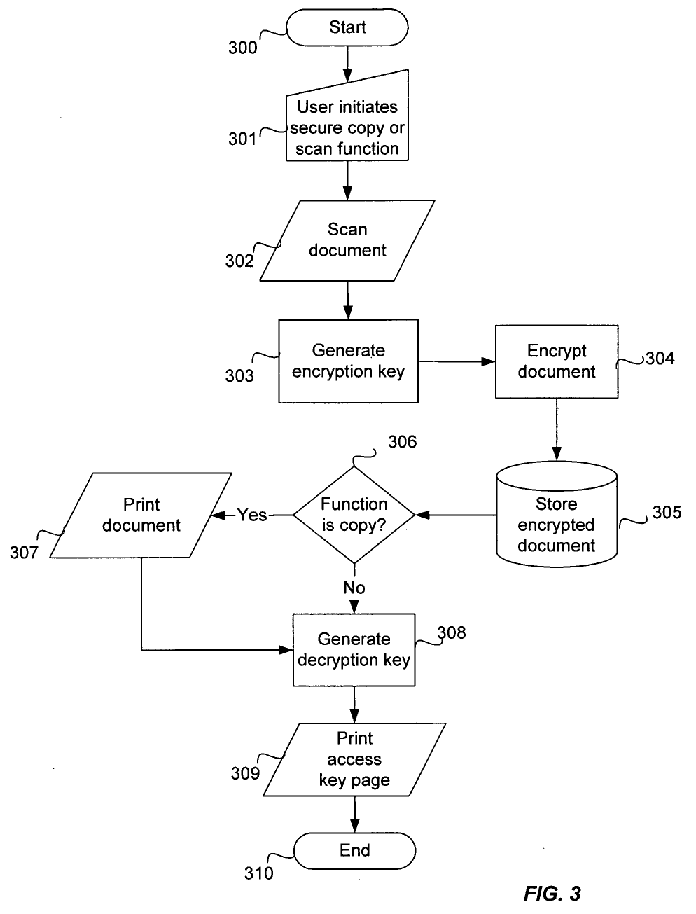

Referring now to FIG. 1, there is shown a block diagram depicting encryption of a document and generation of a physical access key, according to one embodiment of the present invention. Referring also to FIG. 3, there is shown a flow diagram depicting a method of encrypting and storing a document and generating a physical access key, according to one embodiment of the present invention. The method may be performed, for example, by the system depicted in FIG. 1, or by other functional components and systems. The order of the steps in the described embodiment is merely exemplary. One skilled in the art will recognize that the steps can be performed in an order other than what is depicted.

The invention is described herein in the context of a multifunction peripheral (MFP) 101 including scanner 103, encryptor 105, decryptor 106, and printer 110. MFP 101 may also contain other components, some of which may not be required for the operation of this invention. MFP 101 may contain a network interface card (not shown), which can receive processing requests from the external network, a fax interface, media capture devices, and a media capture port. Control interface 112 provides a mechanism by which the user can initiate, configure, monitor, and/or terminate MFP 101 operations, for example, to make copies, scan documents, and print faxes. In one embodiment, interface 112 includes a keypad, display, touchscreen, or any combination thereof.

MFP 101 can access other forms of media through electronic data input peripherals which may include magnetic media readers for magnetic media such as floppy disks, magnetic tape, fixed hard disks, removable hard disks, and memory cards. Peripherals may also include optical media readers for optical storage media such as CDs, DVDs, magneto-optical disks, and the like. In addition, the MFP 101 may contain a non-volatile storage area, which might be a disk drive or any other memory storage area, and a processor that controls the operation of the MFP components. In FIG. 1, MFP 101 is shown communicatively coupled to storage 108, which may be a hard drive or other storage device.

MFP 101 is configured to receive original document 102, for example using scanner 103. Original document 102 can be any kind of document, including but not limited to text, word processing and spreadsheet files, email messages, voice and audio recordings, images and video recordings.

The user initiates 301 a secure copy or secure scan function using control interface 112, and provides original document 102 at scanner 103. Alternatively, MFP 101 may be configured to begin the encryption and storage method automatically upon receiving a document at scanner 103, without the user having to explicitly initiate the operation.

MFP 101 may also have any combination of input mechanisms known to persons of ordinary skill in the art, such as fax machines or email capabilities, in accordance with the principles of this invention. In other embodiments, therefore, document 102 may be received by email, fax, or other mechanisms. Scanner 103 scans original document 102, converting it into electronic form as digital document 104. Methods of converting documents into electronic form using scanners are well known in the art.

Encryptor 105 then generates 303 encryption key. In one embodiment, MFP 101 generates 303 one encryption key per document 102; in other embodiments, it generates one key per page, or uses the same encryption key for multiple documents. Alternatively, rather than generating 303 an encryption key, MFP 101 can use an existing key. The user can input a key by, for example, providing a physical artifact with a key printed on it for scanning by MFP 101 or by typing a key into control interface 112.

In embodiments where a single key is generated 303 for each document, MFP 101 can detect how many documents 102 are present using any of a variety of methods. For example: the user can indicate, via interface 112, how many documents 102 are present; or each file or stack of papers can be counted as a separate document 102; or a machine-readable coversheet or divider may signal a new document 102; or a period of delay between inputs may signal a new document 102. One skilled in the art will recognize a variety of other ways for MFP 101 to determine the number of documents 102 and/or the number of pages in each document 102.

Encryptor 105 receives digital document 104 from scanner 103, and encrypts 304 document 104 to generate encrypted document 107. The encryption can be accomplished using any of a variety of methods known in the art, including symmetric or asymmetric techniques, such as the RSA PKCS algorithms.

Encryptor 105 stores 305 encrypted document 107 in storage 108. Storage device 108 is a hard drive or other device capable of storing encrypted documents 107, for example in database form. Storage device 108 may be at the same location as MFP 101, or it may be remotely located, connected for example via a network.

In one embodiment, only the encrypted version is stored 305; any unencrypted transient copies (such as temporary copies maintained in memory during the encryption process) are purged from memory and are never stored to persistent media such as disk.

If the user requested 306 that MFP 101 make a copy of scanned document 102, then printer 110 prints document 102. If the copy function was not selected 306, then the printing step 307 is skipped. In one embodiment, printing a copy can be provided as a default operation; in another embodiment, the user can configure the default as desired.

Encryptor 105 generates 308 decryption key 109 that can later be used for decryption of encrypted document 107. For symmetric encryption, decryption key 109 is identical to the encryption key; for asymmetric encryption, decryption key 109 differs from (and usually cannot be derived from) the encryption key.

Printer 110 (or other output device) receives decryption key 109 generated by encryptor 105 and outputs 309 physical artifact 111 containing a representation of decryption key 109. In one embodiment, physical artifact 111 is a piece of paper containing a printed representation of decryption key 109. The printer output is therefore an example of a physical access key as provided by the present invention. Accordingly, artifact 111 is also referred to herein as an access key page.

In some embodiments, the representation of the key is humanreadable, such as an alphanumeric code. In other embodiments, the representation of the key may be a machine-readable code such as a barcode. Other possible representations of the key are any unique combination of identifying marks which either a human or a machine can read. One skilled in the art will also recognize that in alternative embodiments, other forms of non-electronic physical artifacts are generated (such as cards, key fobs, and the like); in such embodiments, a device other than a printer may be provided to generate the physical artifact.

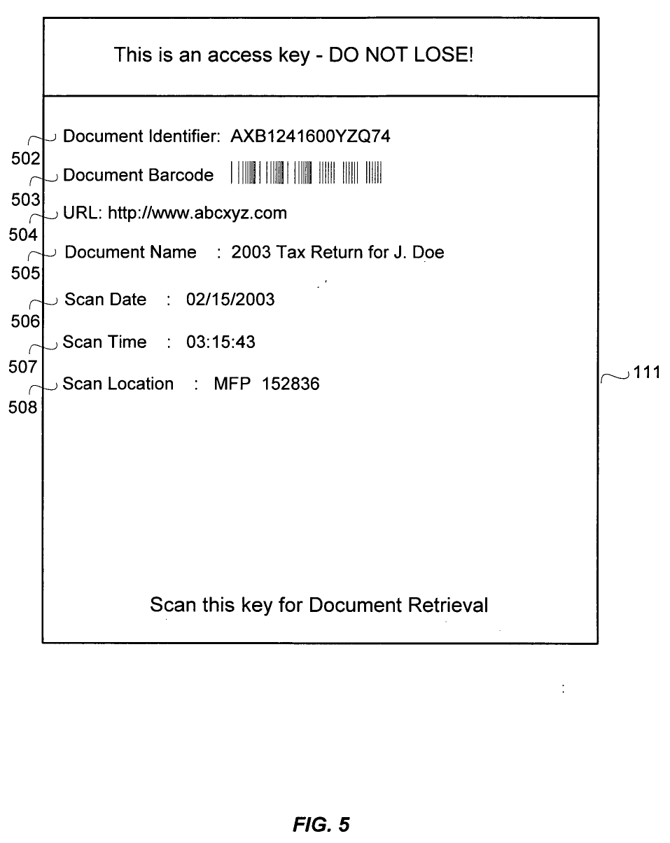

FIG. 5 depicts a sample physical artifact 111 that acts as an access key for an encrypted document 107. In this sample, printed on the physical artifact 111 is document identifier 502, barcode 502 containing decryption key 109, document name 505, scan date 506, scan time 507, and scan location 508. One skilled in the art will recognize that the particular combination of items printed on artifact 111 of FIG. 5 is merely exemplary, and that any such items may be omitted or provided in any combination without departing from the essential characteristics of the invention. In some embodiments, the physical artifact is a piece of paper. In other embodiments, the physical artifact may be an identification card or a variety of other non-electronic media known to one of ordinary skill in the art.

For example, in one embodiment, as described in more detail below, barcode 503 includes a representation of the document's location, such as via an encoded URL or other pointer, so that the system can scan both the location identifier and the decryption key 109 in one operation. The physical access key 111 can also contain any or all of the following, in any combination: the URL 504 in human-readable form; an indication of who encrypted the document; an indication of the author of the document; the size of the document; a thumbnail representation of a cover page; an indication of whether the key carries a watermark; and/or any other information relating to the document. In one embodiment, physical access key 111 includes a series of thumbnail images, one per page, depicting the complete contents of the document. Any of the above suggested or other desired information about the document can be printed on the physical access key 111 in a machine-readable format (such as a barcode), a human-readable format, or both. Information printed on artifact 111 may be presented and arranged in any form.

In some embodiments, the system never stores a persistent copy of decryption key 109 or any representation of key 109. In other embodiments, the system deletes any copies of key 109 or any representations of key 109 after printing it out. In both instances, no copy of key 109 or representation of key 109 is retained in storage once key 109 is printed out.

Retrieving a Securely Stored Digital Document

Once encrypted document 107 has been stored in storage 108 and physical artifact 111 has been generated, the document is fully secure and can be retrieved only upon presentation of physical artifact 111 (or, in one embodiment, upon manual entry of decryption key 109 or other code presented on artifact 111). To retrieve and decrypt document 107, the user who encrypted the document (or some other individual) presents artifact 111 for scanning by MFP 101.

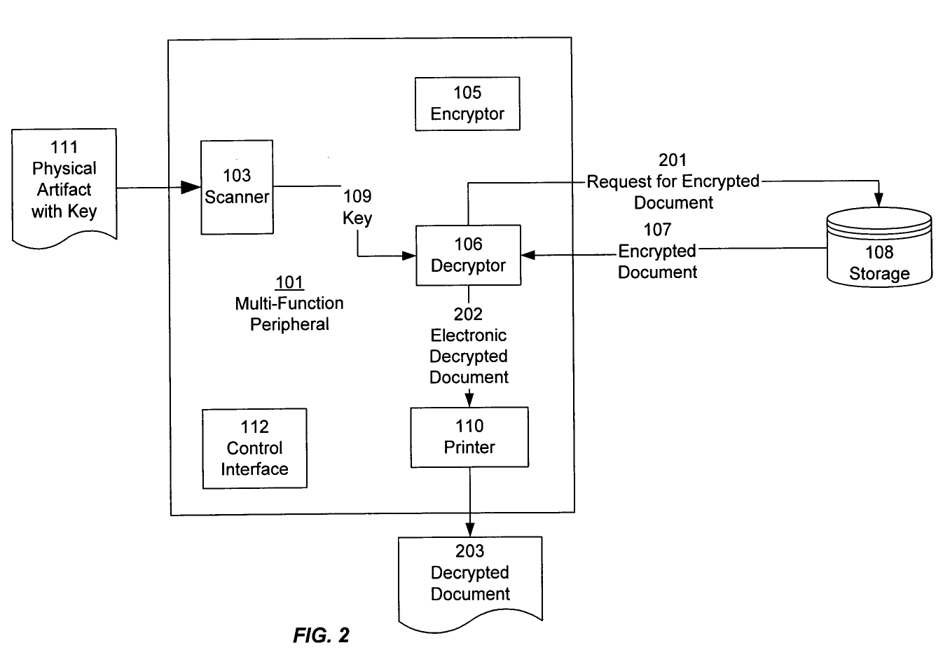

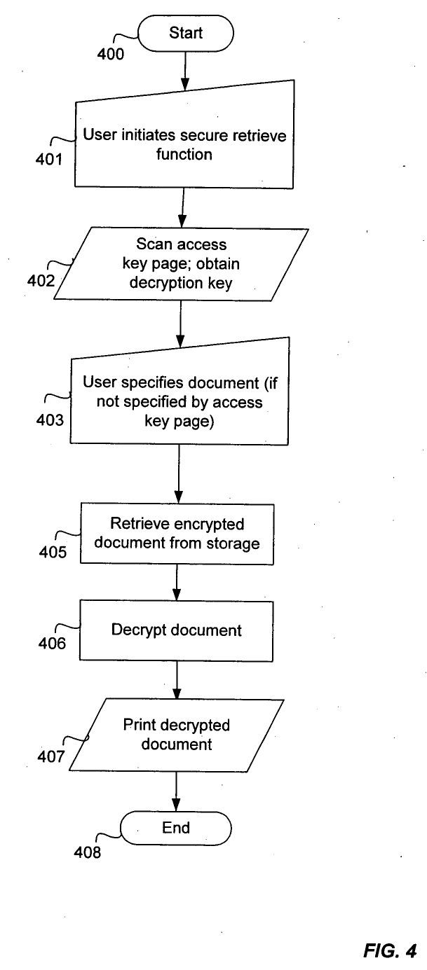

Referring now to FIG. 2, there is shown a block diagram depicting retrieval and decryption of a securely stored and encrypted document 107, according to one embodiment of the present invention. Referring also to FIG. 4, there is shown a flow diagram depicting a method of accessing a stored document using a physical access key, according to one embodiment of the present invention. The method may be performed, for example, by the system depicted in FIG. 2, or by other functional components and systems. Again, the order of the steps in the described embodiment is merely exemplary, and one skilled in the art will recognize that the steps can be performed in an order other than what is depicted.

The user initiates 401 a secure retrieve function, for example by entering a command via control interface 112 or by simply presenting physical artifact 111 (also referred to as an access key page) to scanner 103. In other embodiments the default of the system is a secure retrieve function, eliminating the need for the user to explicitly specify the secure retrieve function.

In one embodiment, scanner 103 scans 402 physical artifact 111 to obtain decryption key 109. In other embodiments, a user can input the key, for example by typing it into a keypad of control interface 112. One of ordinary skill in the art will recognize that a variety of additional mechanisms for inputting decryption key 109 can be used in place of scanner 103.

The user then specifies the document 403. In some embodiments, artifact 111 itself contains information (such as a file name, storage location, or link to the storage location) sufficient for MFP 101 to identify encrypted document 107 in storage 108. For example, artifact 111 may include a pointer, such as a URL (Uniform Resource Locator) indicating the document; the pointer may be provided in human-readable form, or as a bar code, or it may be embedded in the barcode that represents key 109. If the document is specified by artifact 111, step 403 can be skipped. In other embodiments, the user specifies the location of the document, for example by using control interface 112 to browse within a file system, type in a file name, enter a keyword search, or the like.

MFP 101 retrieves 405 document 107 from storage 108. In one embodiment, MFP 101 generates request 201 for document 107 from storage 108, and receives encrypted document 107. Request 201 may be a conventional “get file” request according to well known file access protocols.

Decryptor 106 then uses key 109 to decrypt 406 encrypted document 107, and then sends decrypted document 202 to an output mechanism of MFP 101, in this case printer 110. Document 202 is then printed 407. One of skill in the art will recognize that other output devices can be used, in lieu of a printer 110, for outputting the document.

In some embodiments, no electronic copy of decrypted document 202 is ever retained anywhere in memory. In other embodiments, to the extent that any electronic copy of decrypted document 202 is generated, such copies are used only transiently, are deleted after the decrypted document 202 is output, and are never stored to disk or other persistent media.

Additional Functionality

In addition to the above features and elements, other functionality may be included in various embodiments of the invention. The following are examples of other features and elements that can be included alone or in any combination.

Logging Key Usage. In one embodiment, MFP 101 maintains a log describing each use of key 109 to access document 107. Methods of creating and storing usage logs are well known in the art of computer science. This log may be internal to MFP 101 or located at a remote or local server or storage device. The log may be used, for example, to monitor the timing and usage amounts of key 109, to monitor which documents 107 have been accessed by each user, to confirm receipt by an intended user, to verify how many reproductions of document 107 exist, to signal tampering or failed attempts to access documents 107, and to generate reports on these activities or other uses of the system. In some embodiments, MFP 101 may consult the log before decrypting document 107, and will decline to decrypt document 107 when the log indicates suspicious or unauthorized attempts to retrieve document 107. In other embodiments, as described in more detail below, keys 109 may expire after a predetermined number of attempts to retrieve document 107, or after a predetermined time period has expired since key 109 was issued; in such embodiments, MFP 101 may consult the log to determine how many times document 107 has been retrieved.

Verification Test. In one embodiment, document access is subject to an identity check, even when physical artifact 111 is presented. Thus, as an additional security measure, MFP 101 requires that the user presenting artifact 111 provide some indicia of identification before document 107 is decrypted. For example, MFP 101 may require that the user enter a personal password, or MFP 101 may perform a biometric scan such as a fingerprint, voiceprint, or retinal scan, or an additional physical access key may be required. One of ordinary skill in the art can readily determine various appropriate tests in light of this description. The verification test may be useful to minimize unauthorized use of the key. In some embodiments, a user can indicate to MFP 101 that a particular key should be cancelled, so that it cannot be used. This may be useful, for example, if the user discovers that the key has been stolen, misplaced, or that an unauthorized copy has been made.

Key Expiry. In one embodiment, keys 109 expire after one use, or a predetermined number of uses, or after a predetermined time period. These expiry criteria can be specified by the user that originally scans the document, or they can be default criteria, or they can be manually entered by the user or some other authorized individual. An artifact 111 containing an expired key 109 cannot be used to access document 107.

Several techniques might be used to prevent unauthorized access to a document that has expired. One technique is to retain an expiration date at MFP 101; after the date has passed, MFP 101 denies any requests for retrieval of encrypted document 107. In one embodiment, an administrator might be able to access document 107 for archival purposes, but a normal user could not cause document 107 to be reprinted.

According to a second technique, MFP 101 destroys the stored encrypted document 107 on the expiration date.

According to a third technique, a two-part decryption key is used. A first component, k1, is printed on physical artifact 111. A second component, k2, is stored in storage 108, or in some other location. In one embodiment, encrypted document 107 can be stored on an untrusted storage medium, while key component k2 is stored in a more secure storage environment, such as within the originating MFP 101 or in an expiry key server (not shown). In one embodiment, MFP 101 can only decrypt document 107 when k1 and k2 are available and combined.

Key components k1 and k2 can be generated according to a number of different techniques. For example, decryption key 109 can be split into two smaller bit sequences that can be concatenated to reconstitute the decryption key. Alternatively, two key components k1 and k2 can be made the same length as a full decryption key 109; k1 and k2 are then combined (for example using a bitwise XOR operation) to form the actual decryption key 109. This latter method has the advantage that a casual examination of physical artifact 111 including key component k1 would not reveal that the key might expire or that it is not a full decryption key 109, as the length would be identical to that of a non-expiring key. Those skilled in the art will appreciate that there are many methods of splitting and combining decryption keys 109, any of which might be used to implement the invention.

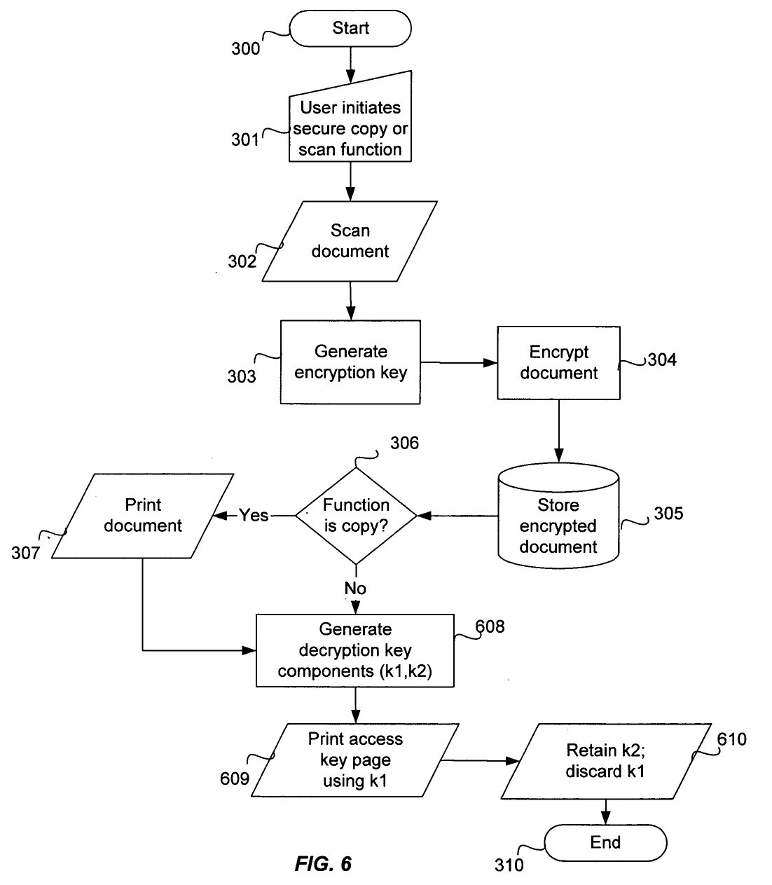

Referring now to FIG. 6, there is shown a flow diagram depicting a method of encrypting and storing a document and generating a physical access key, using a split key according to one embodiment of the present invention. Steps 301 through 307 are identical to those described above in connection with FIG. 3. Encryptor 105 then generates 608 decryption key components (k1, k2) that, when combined, can be used to decrypt document 107. Printer 110 (or other output device) receives decryption key component k1 and outputs 609 physical artifact 111 containing a representation of decryption key component k1. MFP 101 then retains 610 decryption key component k2 and discards any remaining electronic copies of component k1. As an alternative to retaining decryption key component k2 locally at MFP 101, MFP 101 can transmit k2 to an expiry key server or some other storage device. Optionally, an expiry date can also be stored along with k2.

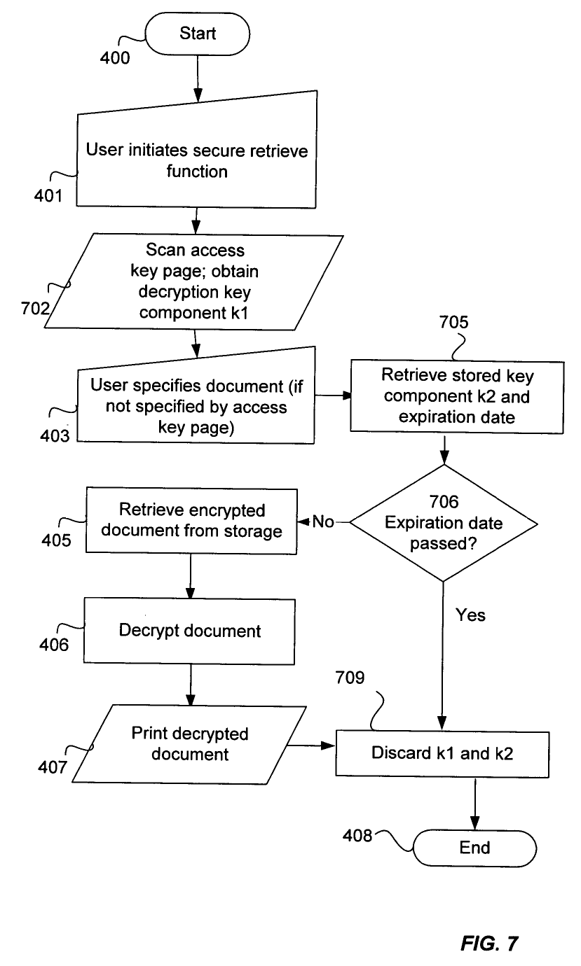

Referring now to FIG. 7, there is shown a flow diagram depicting a accessing a stored document using a physical access key, using a split key according to one embodiment of the present invention. The user initiates 401 a secure retrieve function as described above in connection with FIG. 4. Scanner 103 then scans 702 physical artifact 111 to obtain decryption key component k1. The user then specifies the document 403. As described above, in some embodiments, artifact 111 itself contains information (such as a file name, storage location, or link to the storage location) sufficient for MFP 101 to identify encrypted document 107 in storage 108.

MFP 101 then retrieves 705 stored key component k2 (and the expiration date for document 107, if applicable). MFP 101 then checks 706 whether the expiration date has passed. If not, it retrieves 405 encrypted document 107 from storage 108, decrypts 406 document 107 using the combination of k1 and k2, and prints 407 the decrypted document. It then discards 709 any remaining electronic copies of k1 and k2.

If, in 706, the expiration date has passed, MFP 101 discards 709 electronic copies of k1 and k2, and does not decrypt or print document 107.

Watermarking. In some embodiments, MFP 101 includes a watermark on printed decrypted document 203. The watermark indicates, by some visible indicia on printed document 203, which artifact 111 was used to obtain access to the document.

In one embodiment, when a user provides document 102 for scanning by MFP 101, the user indicates that document 102 should be watermarked. If desired, the user can specify, via control interface 112, particular watermarks for particular recipients of document 102; for example, the recipient's name (or some other identifier) can be used as a watermark. Alternatively, MFP 101 can generate a unique, arbitrary watermark, either at the time document 102 is scanned or at the time printed document 203 is generated. In one embodiment, artifact 111 includes a coded representation of the watermark, so that when artifact 111 is used to retrieve document 107, the watermark is included in the printed document 203. In another embodiment, the watermark is stored, for example in storage 108, in a record associated with artifact 111; thus, when artifact 111 is used to retrieve document 107, the watermark information is retrieved from storage 108 and included in the printed document 203. In yet another embodiment in which a user identifies him- or herself when attempting to retrieve a document 107 (for example by presenting some identifying indicia, such as an identification card, biometric data, a password or code, or a piece of paper), MFP 101 includes in the printed document 203 a watermark identifying the user requesting the document. If appropriate, MFP 101 can perform a verification, such as a checksum verification, on the watermark data.

One skilled in the art will recognize that other arrangements for specifying and generating watermarks are possible. In addition to any of these watermark schemes, the watermark may also indicate additional information, such as the date and time of the printout, or a serial count indicating how many times that particular artifact 111 has been used, or a serial count indicating how many times the document has been printed.

If automatically generated watermarking is used, the user requesting the watermarking can specify how many different watermarks are desired. MFP 101 can generate the specified number of distinct watermarks to be printed. When the decryption key representation is created, the watermarking data may be included as part of the same key representation printed on the physical artifact. Alternatively, a representation of the watermarking data may be included as a separate code, for example a separate barcode on the same physical artifact as the decryption key, or a representation of the watermarking data may be printed on a separate physical artifact.

In any of the above watermarking schemes, in one embodiment MFP 101 applies the watermark to the printed document 203 using steganographic techniques. One skilled in the art will recognize that other types of watermarks could also be used.

Document Versions. In another embodiment, depending on the identity of the individual attempting to access the document 107, the document printout itself is varied. The present invention can therefore vary the characteristics of the document itself (for example, omitting or redacting certain sections, or emphasizing certain sections), in addition to or instead of including different watermarks for different individuals. The variations in the document can be associated with the particular artifact 111 used to access the document, or they can be associated with the particular recipient (based on the recipient's identifying indicia). The variations in the document can be specified by the user who originally inputs the document 102 into MFP 101, or they can be specified by the recipient at the time of printout.

Physical Artifact on Collection Coversheet. In one embodiment, the present invention is implemented in connection with a technique for providing collection coversheets as described in the above-referenced related patent applications. In such an embodiment, rather than generating a separate physical artifact 111, MFP 101 can include a representation of decryption key 109 on a collection coversheet that is generated according to the techniques described in the related patent applications. Entire collections can be encrypted in accordance with the techniques described herein, with an artifact 111 being generated for each document in the collection, or for the collection as a whole. One skilled in the art will recognize that other variations for encrypting document collections and providing artifacts 111 may be implemented without departing from the essential characteristics of the present invention.

1. A method for securely storing a document, comprising:
receiving a document;
encrypting the received document using an encryption key;
generating a decryption key for decrypting the document;
storing the encrypted document; and
outputting, on non-electronic media, a physical artifact comprising a representation of the key presentable for decryption.

2. The method of claim 1, wherein the step of encrypting the received document is performed without creating any persistent copies of the unencrypted document, and wherein the step of generating a key is performed without creating any persistent copies of the key.

3. The method of claim 1, further comprising:
destroying any transient electronic copies of the unencrypted document; and
destroying any transient electronic copies of the key.

4. The method of claim 1, wherein the encryption key is identical to the decryption key.

5. The method of claim 1, wherein the encryption key is different from the decryption key.

6. The method of claim 1, wherein receiving a document comprises receiving a collection of files.

7. The method of claim 1, wherein receiving a document comprises:
receiving at least one file from a first source; and
receiving at least one file from a second source.

8. The method of claim 7, wherein each of the sources comprises one selected from the group consisting of:
a scanner;
a camera;
a memory card;
a storage device;
a facsimile source;
an email source; and
a wireless source.

9. The method of claim 7, wherein receiving a document comprises receiving a document from at least one selected from the group consisting of:
a scanner;
a camera;
a memory card;
a storage device;
a facsimile source;
an email source; and
a wireless source.

10. The method of claim 1, further comprising:
printing the document.

11. The method of claim 1, wherein outputting the physical artifact comprising the representation of the key comprises printing the representation of the key on a piece of paper.

12. The method of claim 1, wherein outputting the representation of the key comprises printing a bar code representing the key.

13. The method of claim 1, wherein outputting the representation of the key comprises printing a human-readable representation of the key.

14. The method of claim 1, wherein outputting the representation of the key comprises generating a physical artifact comprising the representation of the key.

15. The method of claim 1, further comprising storing a watermark indication for the document.

16. The method of claim 1, further comprising storing an expiry criterion for the decryption key.

17. The method of claim 1, wherein outputting the physical artifact further comprises outputting, on the physical artifact, an expiry criterion for the decryption key.

18. The method of claim 16 or 17, wherein the expiry criterion comprises at least one selected from the group consisting of:
a maximum number of uses of the decryption key;
a time period;
a date; and
a time.

19. The method of claim 16 or 17, further comprising:
receiving the representation of the key;
responsive to receiving the representation of the key:
determining, based on the expiry criterion, whether the key has expired; and
responsive to non-expiry of the key:
retrieving the stored encrypted document;
decrypting the retrieved document using the key; and
outputting the document.

20. The method of claim 16 or 17, further comprising, responsive to expiration of the decryption key according to the expiry criterion, deleting the encrypted document.

21. The method of claim 1, wherein the physical artifact further comprises a pointer to the encrypted document.

22. The method of claim 21, wherein the pointer is machine-readable.

23. The method of claim 21, wherein the pointer comprises at least one selected from the group consisting of:
a filename;
a file identifier;
a uniform resource locator;
a storage location;
an IP address;
a domain name; and
an alias.

24. The method of claim 1, further comprising:
receiving the representation of the key; and
responsive to receiving the representation of the key:
retrieving the stored encrypted document;
decrypting the retrieved document using the key; and
outputting the document.

25. The method of claim 24, wherein receiving the representation of the key comprises scanning a physical artifact comprising the representation of the key.

26. The method of claim 24, further comprising storing a watermark indication for the document, and wherein outputting the document comprises outputting the document including the indicated watermark.

27. The method of claim 26, wherein receiving the representation of the key comprising receiving a user identifier, and wherein the indicated watermark identifies the user corresponding to the identifier.

28. The method of claim 1, further comprising:
receiving the representation of the key;
receiving a user identifier; and
determining whether the identified user is authorized to receive the document;
responsive to the identified user being authorized to receive the document:
retrieving the stored encrypted document;
decrypting the retrieved document using the key; and
outputting the document.

29. The method of claim 28, wherein receiving the user identifier comprises receiving at least one selected from the group consisting of:
a biometric indicator of the user's identity; and
user input verifying the user's identity.

30. The method of claim 1, further comprising:
receiving the representation of the key;
receiving a user identifier; and
responsive to the user identifier, selecting a version of the document from a plurality of versions;
retrieving the stored encrypted document;
decrypting the retrieved document using the key; and
outputting the selected version of the document.

31. The method of claim 30, further comprising, prior to outputting the selected version, generating the selected version by changing at least one characteristic of the retrieved document.

32. A method for securely storing a document, comprising:
receiving a document;
encrypting the received document using an encryption key;
generating a decryption key for decrypting the document;
generating, from the decryption key, at least two key components combinable to reconstitute the decryption key;
storing the encrypted document;
storing a first subset of the key components, wherein at least one key component is not included in the first subset; and
outputting, on non-electronic media, a physical artifact comprising a representation of a second subset of the key components, wherein at least one key component is not included in the second subset;
wherein each subset comprises at least one key component.

33. The method of claim 32, further comprising destroying any transient electronic copies of the second subset of the key components.

34. The method of claim 32, further comprising:
receiving the representation of the second subset of the key components; and
responsive to receiving the representation of the second subset:
retrieving the stored encrypted document;
retrieving the first subset of the key components;
combining the first subset and the second subset to reconstitute the decryption key;
decrypting the retrieved document using the decryption key; and
outputting the document.

35. The method of claim 32, further comprising storing an expiry criterion for the decryption key.

36. The method of claim 32, wherein outputting the physical artifact further comprises outputting, on the physical artifact, an expiry criterion for the decryption key.

37. The method of claim 35 or 36, further comprising:
receiving the representation of the second subset of the key components;
responsive to receiving the representation of the second subset:
determining, based on the expiry criterion, whether the key has expired; and
responsive to non-expiry of the key:
retrieving the stored encrypted document;
retrieving the first subset of the key components;
combining the first subset and the second subset to reconstitute the decryption key;
decrypting the retrieved document using the decryption key; and
outputting the document.

38. The method of claim 35 or 36, further comprising, responsive to expiration of the decryption key according to the expiry criterion:
deleting the encrypted document; and
deleting the first subset of the key components.

39. A method for retrieving a stored encrypted document, comprising:
receiving a physical artifact comprising a representation of a key for decrypting the document;
responsive to receiving the physical artifact, automatically performing the steps of:
retrieving the document from a storage device;
decrypting the retrieved document using the key; and
outputting the decrypted document.

40. The method of claim 39, wherein the physical artifact comprises a piece of paper.

41. The method of claim 39, wherein receiving a physical artifact comprises scanning a bar code.

42. The method of claim 39, wherein the physical artifact further comprises a pointer to the encrypted document and wherein retrieving the document comprises retrieving the document from a location specified by the pointer.

43. The method of claim 42, wherein the pointer comprises at least one selected from the group consisting of:
a filename;
a file identifier;
a uniform resource locator;
a storage location;
an IP address;
a domain name; and
an alias.

44. The method of claim 39, wherein outputting the decrypted document comprises outputting the document including a watermark.

45. The method of claim 44, wherein the watermark is uniquely associated with the physical artifact.

46. The method of claim 44, further comprising receiving a user identifier, and wherein the indicated watermark identifies the user corresponding to the identifier.

47. A method for retrieving a stored encrypted document, comprising:
receiving a physical artifact comprising a representation of a key for decrypting the document;
receiving a user identifier; and
determining whether the identified user is authorized to receive the document;
responsive to the identified user being authorized to receive the document:
retrieving the stored encrypted document;
decrypting the retrieved document using the key; and
outputting the document.

48. A method for retrieving a stored encrypted document, comprising:
receiving a physical artifact comprising a representation of a key for decrypting the document;
receiving a user identifier; and
responsive to the user identifier, selecting a version of the document from a plurality of versions;
retrieving the stored encrypted document;
decrypting the retrieved document using the key; and
outputting the selected version of the document.

49. The method of claim 48, further comprising, prior to outputting the selected version, generating the selected version by changing at least one characteristic of the retrieved document.

50. A computer program product for securely storing a document, comprising:
a computer-readable medium; and
computer program code, encoded on the medium, for:
receiving a document;
encrypting the received document using an encryption key;
generating a decryption key for decrypting the document;
storing the encrypted document; and
outputting, on non-electronic media, a physical artifact comprising a representation of the key presentable for decryption.

51. The computer program product of claim 50, wherein the computer program code for receiving a document comprises computer program code for scanning a document.

52. The computer program product of claim 50, wherein the computer program code for receiving a document comprises computer program code for receiving a document from at least one selected from the group consisting of:
a scanner;
a camera;
a memory card;
a storage device;
a facsimile source;
an email source; and
a wireless source.

53. The computer program product of claim 50, wherein the computer program code for outputting the physical artifact comprising the representation of the key comprises computer program code for printing the representation of the key on a piece of paper.

54. The computer program product of claim 50, further comprising computer program code for storing a watermark indication for the document.

55. The computer program product of claim 50, further comprising computer program code for storing an expiry criterion for the decryption key.

56. The computer program product of claim 50, wherein the computer program code for outputting the physical artifact further comprises computer program code for outputting, on the physical artifact, an expiry criterion for the decryption key.

57. The computer program product of claim 55 or 56, further comprising:
receiving the representation of the key;
responsive to receiving the representation of the key:
determining, based on the expiry criterion, whether the key has expired; and
responsive to non-expiry of the key:
retrieving the stored encrypted document;
decrypting the retrieved document using the key; and
outputting the document.

58. The computer program product of claim 55 or 56, further comprising computer program code for, responsive to expiration of the decryption key according to the expiry criterion, deleting the encrypted document.

59. The computer program product of claim 50, wherein the physical artifact further comprises a pointer to the encrypted document.

60. The computer program product of claim 50, further comprising computer program code for:
receiving the representation of the key; and
responsive to receiving the representation of the key:
retrieving the stored encrypted document;
decrypting the retrieved document using the key; and
outputting the document.

61. The computer program product of claim 60, wherein the computer program code for receiving the representation of the key comprises computer program code for scanning a physical artifact comprising the representation of the key.

62. The computer program product of claim 60, further comprising computer program code for storing a watermark indication for the document, and wherein the computer program code for outputting the document comprises computer program code for outputting the document including the indicated watermark.

63. The computer program product of claim 50, further comprising computer program code for:
receiving the representation of the key;
receiving a user identifier; and
determining whether the identified user is authorized to receive the document;
responsive to the identified user being authorized to receive the document:
retrieving the stored encrypted document;
decrypting the retrieved document using the key; and
outputting the document.

64. The computer program product of claim 50, further comprising computer program code for:
receiving the representation of the key;
receiving a user identifier; and
responsive to the user identifier, selecting a version of the document from a plurality of versions;
retrieving the stored encrypted document;
decrypting the retrieved document using the key; and
outputting the selected version of the document.

65. A computer program product for securely storing a document, comprising:
a computer-readable medium; and
computer program code, encoded on the medium, for:
receiving a document;
encrypting the received document using an encryption key;
generating a decryption key for decrypting the document;
generating, from the decryption key, at least two key components combinable to reconstitute the decryption key;
storing the encrypted document;
storing a first subset of the key components, wherein at least one key component is not included in the first subset; and
outputting, on non-electronic media, a physical artifact comprising a representation of a second subset of the key components,
wherein at least one key component is not included in the second subset;
wherein each subset comprises at least one key component.

66. The computer program product of claim 65, further comprising computer program code for:
receiving the representation of the second subset of the key components; and
responsive to receiving the representation of the second subset:
retrieving the stored encrypted document;
retrieving the first subset of the key components;
combining the first subset and the second subset to reconstitute the decryption key;
decrypting the retrieved document using the decryption key; and
outputting the document.

67. The computer program product of claim 65, further comprising computer program code for storing an expiry criterion for the decryption key.

68. The computer program product of claim 65, wherein the computer program code for outputting the physical artifact further comprises computer program code for outputting, on the physical artifact, an expiry criterion for the decryption key.

69. The computer program product of claim 67 or 68, further comprising computer program code for:
receiving the representation of the second subset of the key components;
responsive to receiving the representation of the second subset:
determining, based on the expiry criterion, whether the key has expired; and
responsive to non-expiry of the key:
retrieving the stored encrypted document;
retrieving the first subset of the key components;
combining the first subset and the second subset to reconstitute the decryption key;
decrypting the retrieved document using the decryption key; and
outputting the document.

70. A computer program product for retrieving a stored encrypted document, comprising:
a computer-readable medium; and
computer program code, encoded on the medium, for:
receiving a physical artifact comprising a representation of a key for decrypting the document;
responsive to receiving the physical artifact, automatically performing the steps of:
retrieving the document from a storage device;
decrypting the retrieved document using the key; and
outputting the decrypted document.

71. The computer program product of claim 70, wherein the computer program code for outputting the decrypted document comprises computer program code for outputting the document including a watermark.

72. A computer program product for retrieving a stored encrypted document, comprising:
a computer-readable medium; and
computer program code, encoded on the medium, for:
receiving a physical artifact comprising a representation of a key for decrypting the document;
receiving a user identifier; and
responsive to the user identifier, selecting a version of the document from a plurality of versions;
retrieving the stored encrypted document;
decrypting the retrieved document using the key; and
outputting the selected version of the document.

73. A system for securely storing a document, comprising:
a document receiving device, for receiving a document;
an document encryptor, coupled to the document receiving device, for encrypting the received document using an encryption key, and for generating a decryption key for decrypting the document;
a storage device, coupled to the document encryptor, for storing the encrypted document; and
an output device, coupled to the document encryptor, for outputting, on non-electronic media, a physical artifact comprising a representation of the key presentable for decryption.

74. The system of claim 73, wherein the document receiving device comprises at least one selected from the group consisting of:
a scanner;
a camera;
a memory card;
a storage device;
a facsimile receiver;
an email receiver; and
a wireless receiver.

75. The system of claim 73, wherein the output device comprises a printer, for printing the representation of the key on a piece of paper.

76. The system of claim 73, wherein the storage device stores an expiry criterion for the decryption key.

77. The system of claim 73, wherein the output device outputs, on the physical artifact, an expiry criterion for the decryption key.

78. The system of claim 76 or 77, further comprising:
a key receiving device, for receiving the representation of the key;
a processor, coupled to the key receiving device, for determining, based on the expiry criterion, whether the key has expired;
a document retriever, coupled to the processor, for, responsive to the processor determining that the key has not expired, retrieving the stored encrypted document from the storage device;
a document decryptor, coupled to the document retriever, for, responsive to the processor determining that the key has not expired, decrypting the retrieved document using the key; and
a document output device, coupled to the document decryptor, for, responsive to the processor determining that the key has not expired, outputting the document.

79. The system of claim 76 or 77, wherein, responsive to expiration of the decryption key according to the expiry criterion, the storage device deletes the encrypted document.

80. The system of claim 73, wherein the physical artifact further comprises a pointer to the encrypted document.

81. The system of claim 73, further comprising:
a key receiving device, for receiving the representation of the key;
a document retriever, coupled to the key receiving device, for retrieving the stored encrypted document from the storage device;
a document decryptor, coupled to the document retriever, for decrypting the retrieved document using the key; and
a document output device, coupled to the document decryptor, for outputting the document.

82. The system of claim 81, wherein the key receiving device comprises a scanner.

83. The system of claim 81, wherein the storage device stores a watermark indication for the document, and wherein the document output device outputs the document including the indicated watermark.

84. The system of claim 73, further comprising:
a key receiving device, for receiving the representation of the key;
a user authenticator, for receiving a user identifier; and
a processor, coupled to the user authenticator, for determining whether the identified user is authorized to receive the document;
a document retriever, coupled to the storage device and to the processor, for, responsive to the identified user being authorized to receive the document, retrieving the stored encrypted document from the storage device;
a document decryptor, coupled to the document retriever, for, responsive to the identified user being authorized to receive the document, decrypting the retrieved document using the key; and
a document output device, coupled to the document decryptor, for, responsive to the identified user being authorized to receive the document, outputting the document.

85. The system of claim 73, further comprising:
a key receiving device, for receiving the representation of the key;
a user authenticator, for receiving a user identifier; and
a version selector, coupled to the user authenticator, for, responsive to the user identifier, selecting a version of the document from a plurality of versions;
a document retriever, coupled to the storage device and to the version selector, for retrieving the stored encrypted document from the storage device;
a document decryptor, coupled to the document retriever, for decrypting the retrieved document using the key; and
a document output device, coupled to the document decryptor, for outputting the document.

86. A system for securely storing a document, comprising:
a document receiving device, for receiving a document;
an document encryptor, coupled to the document receiving device, for encrypting the received document using an encryption key, and for generating a decryption key for decrypting the document;
a processor, coupled to the document encryptor, for generating, from the decryption key, at least two key components combinable to reconstitute the decryption key;
a storage device, coupled to the document encryptor, for storing the encrypted document; and
a storage device, coupled to the document encryptor, for storing a first subset of the key components, wherein at least one key component is not included in the first subset; and
an output device, coupled to the document encryptor, for outputting, on non-electronic media, a physical artifact comprising a representation of a second subset of the key components, wherein at least one key component is not included in the second subset.
wherein each subset comprises at least one key component.

87. The system of claim 86, further comprising:
a key receiving device, for receiving the representation of the second subset of the key components; and
a document retriever, coupled to the key receiving device, for retrieving the stored encrypted document from the storage device;
a document decryptor, coupled to the document retriever, for decrypting the retrieved document using a combination of the first subset and the second subset of the decryption key; and
a document output device, coupled to the document decryptor, for outputting the document.

88. The system of claim 86, wherein the storage device further stores an expiry criterion for the decryption key.

89. The system of claim 86, wherein the output device further outputs, on the physical artifact, an expiry criterion for the decryption key.

90. The system of claim 88 or 89, further comprising computer program code for:
a key receiving device, for receiving the representation of the second subset of the key components; and
a document retriever, coupled to the key receiving device, for, responsive to non-expiry of the key, retrieving the stored encrypted document from the storage device;
a document decryptor, coupled to the document retriever, for, responsive to non-expiry of the key, decrypting the retrieved document using a combination of the first subset and the second subset of the decryption key; and
a document output device, coupled to the document decryptor, for outputting the document.

91. A system for retrieving a stored encrypted document, comprising:
a key receiver, for receiving a physical artifact comprising a representation of a key for decrypting the document;
a document retriever, coupled to the key receiver, for retrieving the document from a storage device;
a document decryptor, coupled to the document retriever, for decrypting the retrieved document using the key; and
a document output device, coupled to the document decryptor, for outputting the document.

92. The system of claim 91, wherein the document output device outputs the document including a watermark.

93. A system for retrieving a stored encrypted document, comprising:
a key receiver, for receiving a physical artifact comprising a representation of a key for decrypting the document;
a user authenticator, for receiving a user identifier; and
a document version selector, coupled to the user authenticator, for, responsive to the user identifier, selecting a version of the document from a plurality of versions;
a document retriever, coupled to the key receiver, for retrieving the document from a storage device;
a document decryptor, coupled to the document retriever, for decrypting the retrieved document using the key; and
a document output device, coupled to the document decryptor, for outputting the selected version of the document.
